(19) United States
(12) Patent Application Publication
(10) Pub. No.: US 2014/0331897 A1
(43) Pub. Date: Nov. 13, 2014

(54) Wet Process for Recycling Asphalt Shingle in Asphalt Binder

(71) Applicant: Mostafa A. Elseifi, Baton Rouge, LA (US)

(72) Inventor: Mostafa A. Elseifi, Baton Rouge, LA (US)

(73) Assignee: Board of Supervisors of Louisiana State University and Agricultural and Mechanical College, Baton Rouge, LA (US)

(21) Appl. No.: 13/987,325

(22) Filed: Mar. 5, 2013

(51) Int. Cl. C08L 95/00

(52) U.S. Cl. CPC C08L 95/00
USPC 106/281.1

(57) ABSTRACT

A new method is disclosed for recycling waste asphalt shingles in hot mix asphalt, i.e. asphalt pavement construction. Ground asphalt shingles are treated as a binder component instead of as an aggregate component. The recycled asphalt shingles that are blended with virgin binder in a wet process act both as a partial binder replacement and as a binder extender due to the presence of fillers, rubber, and fibers in the processed material.

This invention was made with government support under grant number CMMI-1030184 awarded by the National Science Foundation. The government has certain rights in the invention.

The present invention relates to a method of recycling asphalt shingles in hot mix asphalt by grinding asphalt shingles and blending the ground particles with virgin asphalt binder through a wet process.

The manufacture and use of asphalt-based products, including asphalt roofing shingles, results in the production of considerable amounts of landfill waste. The Environmental Protection Agency estimates that approximately 11 million tons of asphalt roofing shingles are placed in U.S. landfills each year, creating significant environmental concerns. The recycling of these asphalt shingles would reduce landfill waste and offer not only environment benefits, but also significant cost savings benefits. The fee for the disposal of waste shingles in landfills can reach as high as $90 to $100 per ton near large cities. In addition, recent estimates indicate that recycled asphalt shingles (RAS) contain 15% to 35% recyclable asphalt binder. The recycling of this binder could provide an annual savings of $1.1 billion while at the same time helping to reduce non-renewable energy consumption.

However, in order to have an effective recycling method, the addition of recycled material must not have an adverse effect on the quality of the finished asphalt product. One such asphalt product is hot mix asphalt (HMA), which is produced by combining aggregate, typically consisting of crushed stone, with asphalt binder, the tarry black “cement” that binds together the aggregate. Many prior art methods of recycling asphalt shingles in HMA focus on a dry process in which ground asphalt waste is added to the aggregate before mixing with binder to create the finished product. In this conventional process the RAS is typically ground to a uniform particle size ranging from 12.5 to 19.0 mm. Because RAS is added to the aggregate and not the binder, such conventional recycling methods do not allow the user to control the final performance grade (PG) of the binder, which is a critical specification criteria used in selecting the proper asphalt binder for the conditions in which it will be used.

Other methods of recycling asphalt shingles utilize a wet method in which RAS is ground up in a liquid to produce a wet waste product mixture that can be directly used to make new asphalt products. For example, U.S. Pat. No. 5,098,025 discloses a method for recycling asphalt shingles, which consists of grinding RAS to a size of approximately 10 mesh in a liquid that may be either water or a solvent such as mineral spirits or benzene. This method requires the temperature to be controlled such that the mixture does not get so hot that the asphalt particles begin clumping together. The resulting product is a liquid asphalt blend that is not suitable for asphalt pavement construction.

U.S. Pat. No. 6,290,152 discloses another asphalt recycling method and apparatus consisting of a process by which RAS is simultaneously heated and milled to a fine mesh and maintained in suspension in liquid asphalt. The simultaneous heating and milling of the RAS involves a complex apparatus that allows continuous venting to release excess moisture and other gases to prevent an unsafe increase in pressure inside the milling apparatus. Further, the method and apparatus allow for the addition of a processing additive such as liquid asphalt to the RAS during heating and milling. The final product is an asphalt slurry containing 50% or greater ground suspended solids. It is not expected that such asphalt slurry would be suitable for asphalt pavement construction given the stiff characteristics of the binder in the shingle waste.

U.S. Pat. No. 5,334,641 discloses a modified asphalt compound formed by blending HMA with finely ground scrap rubber in a wet process to create what is commonly known as asphalt rubber or crumb rubber modifier.

The present invention provides a new method of recycling waste asphalt shingles in hot mix asphalt (HMA; i.e. asphalt pavement construction), which has technical, economic, and environmental benefits. The present invention treats the ground asphalt shingles as a binder component instead of as an aggregate component. Thus, the RAS that is blended with virgin binder through the novel wet process will act as a partial binder replacement and as a binder extender due to the presence of fillers, rubber, and fibers in the processed RAS material.

In accordance with the present invention, the waste asphalt product is first ground to a fine powder size such that at least 80% of the processed RAS passed sieve No. 200. The unheated ground powder is then blended with heated virgin asphalt binder to produce a modified asphalt binder. The modified asphalt binder can be blended with aggregate in the normal production of hot mix asphalt, which is typically used in pavement for road construction. The proposed wet process offers the potential to increase the percentage of asphalt shingles used in the mixture and may allow for better control of the chemical and physical reactions taking place in the blend. Thus, the novel process allows the user to control the final performance grade (PG) of the modified RAS binder. Further, experimental results show that an optimum shingle content may improve the high temperature grade of the binder without adversely affecting the low temperature grade of the binder.

The present invention is particularly suited to, though not limited to, the utilization of asphalt roofing waste, and particularly asphalt roofing shingles and other shingle manufacturing waste, as the recycled asphalt material. The type of roofing shingles used may be organic or fiberglass shingles, though the invention is not limited to any particular type of shingle.

Two types of virgin binders that are classified as PG 64-22 and PG 52-28 were used to design and evaluate the present invention, though the invention is not intended to be limited to a particular type of binder.

### EXAMPLE 1

### Experimental Program

RAS was provided by construction and demolition processing plants and consisted of either tear off shingles from Missouri (referred to as TMO), or manufactured shingles from Maine (referred to as MAME).

The recycled asphalt waste material was ground to an ultra-fine particle size distribution, at room temperature, using a Pulva-Sizer® hammer mill operating at a high rotational speed of approximately 9,600 rpm. The resulting ground RAS has a size distribution such that 90% of the processed RAS is approximately 200 mesh size.

A virgin binder, such as PG 64-22 or PG 52-28, was heated to approximately 170 to 180 degrees Celsius prior to blending with the ground shingle. Unheated ground shingle was added to the heated virgin binder at modification rates of 10%, 20% and 40% by weight of the binder, to produce a modified binder. The modified binder was mixed at approximately 170 to 180 degrees Celsius using a mechanical shear mixer rotating at a speed of 1500 rpm for approximately 30 minutes to produce the final blend. The modified binder may be directly used to produce hot mix asphalt or other asphalt-based products.

The resulting blends were tested using the Superpave Performance Grade, Confocal Laser-Scanning Microscopy, Cigar Tube Test, and High Pressure Gel Permeation Chromatography. In addition to the prepared blends, a virgin air-blown binder used in the manufacturing of shingles was tested (referred to as SHIN).

Descriptions of examples of these testing methods and detailed results are shown in Appendix A. Generally, the use of RAS as a modifier to the binder increased its viscosity, stiffened the binder at high temperatures, and reduced its elongation properties at low temperatures. The novel process, unlike dry processes previously used, allows for control of the resulting performance grade of the modified binder. The best results were seen when unheated ground shingle was added to the heated virgin binder at a modification rate of 10% or 20%. (See Tables 1-3, below).

TABLE 1
Description of test materials.

| Binder | Shingle | Shingle | |
|---|---|---|---|
| Abbreviation | Content (%) | Source | Description |
| (1) | (2) | (3) | (4) |
| 52-28 | 0 | N/A | Conventional binder with no |
| | | | shingle |
| MAME 1522 | 10 | Manufactured | 52-28 binder with 10% shingle |
| MAME 2522 | 20 | Manufactured | 52-28 binder with 20% shingle |
| MAME 4522 | 40 | Manufactured | 52-28 binder with 40% shingle |
| TMO 1522 | 10 | Tear-off | 52-28 binder with 10% shingle |
| TMO 2522 | 20 | Tear-off | 52-28 binder with 20% shingle |
| TMO 4522 | 40 | Tear-off | 52-28 binder with 40% shingle |
| 64-22 | 0 | N/A | Conventional binder with no |
| | | | shingle |
| MAME 1622 | 10 | Manufactured | 64-22 binder with 10% shingle |
| MAME 2622 | 20 | Manufactured | 64-22 binder with 20% shingle |
| TMO 1622 | 10 | Tear-off | 64-22 binder with 10% shingle |
| TMO 2622 | 20 | Tear-off | 64-22 binder with 20% shingle |
| SHIN | 0 | N/A | Conventional air-blown binder |
| | | | used in shingle manufacturing |
| EXT TMO | 0 | Tear-off | Extracted binder from ground |
| | | | TMO shingle |
| EXT MAME | 0 | Manufactured | Extracted binder from ground |
| | | | MAME shingle |

TABLE 2
Results of Superpave testing (PG 64-22).

| | | Test | | PG 64 + | PG 64 + | PG 64 + | PG 64 + | |
|---|---|---|---|---|---|---|---|---|
| Binder Testing | Spec | Temp | PG 64-22 | 10% MAME | 20% MAME | 10% TMO | 20% TMO | SHIN |
| (1) | (2) | (3) | (4) | (5) | (6) | (7) | (8) | (9) |

Test on Original Binder

| | | | | | | | | |
|---|---|---|---|---|---|---|---|---|
| Dynamic Shear, | 1.00⁺ | 64° C. | 2.16 | 2.66 | 2.7 | 3.06 | 4.165 | 1.08 (100° C.) |
| G*/Sin (δ), (kPa), | 1.00⁺ | 70° C. | 0.993 | 1.28 | 1.23 | 1.38 | 1.91 | — |
| AASHTO T315 | | | | | | | | |
| Rotational | 3.0⁻ | 135° C. | 0.48 | 0.53 | 0.67 | 0.69 | 0.70 | 3.74 |
| Viscosity (Pa · s), | | | | | | | | |
| AASHTO T316 | | | | | | | | |

Tests on RTFO

| | | | | | | | | |
|---|---|---|---|---|---|---|---|---|
| Dynamic Shear, | 2.20⁺ | 64° C. | 4.37 | 5.15 | 7.07 | 11.2 | 7.42 | 2.49 (100° C.) |
| G*/Sin (δ), (kPa), | 2.20⁺ | 70° C. | 1.96 | 2.29 | 3.11 | 4.08 | 3.35 | — |
| AASHTO T315 | | | | | | | | |

Tests on (RTFO + PAV)

| | | | | | | | | |
|---|---|---|---|---|---|---|---|---|
| Dynamic Shear, | 5000⁻ | 28° C. | 2940 | 4050 | 3910 | 3925 | 3350 | 4185 (25° C.) |
| G*Sin (δ), (kPa), | | | | | | | | 5185 (22° C.) |
| AASHTO T315 | | | | | | | | |
| BBR Creep | 300⁻ | −6° C. | 87.19 | 89.91 | 107.96 | 88.61 | 111.36 | 42.5 (0° C.) |
| Stiffness, (MPa), | | −12° C. | 189 | 208.53 | 227.39 | 178.85 | 195.46 | 66.1 (−6°) |
| AASHTO T313 | | | | | | | | |
| Bending Beam | 0.300⁺ | −6° C. | 0.364 | 0.356 | 0.332 | 0.344 | 0.365 | 0.290 (0° C.) |
| m-value | | −12° C. | 0.322 | 0.285 | 0.287 | 0.278 | 0.298 | 0.261 (−6° C.) |
| AASHTO T313 | | | | | | | | |

| | | | | | | |
|---|---|---|---|---|---|---|
| Actual PG Grading | PG | PG | PG | PG | PG | PG 100 |
| | 64-22 | 70-16 | 70-16 | 70-16 | 70-16 | |

TABLE 3
Results of Superpave testing (PG 52-28).

| Binder | | Test | PG 52- | PG 52 + | PG 52 + | PG 52 + | PG 52 + | PG 52 + | PG 52 + |
|---|---|---|---|---|---|---|---|---|---|
| Testing | Spec | Temp | 28 | 10% MAME | 20% MAME | 40% MAME | 10% TMO | 20% TMO | 40% TMO |
| (1) | (2) | (3) | (4) | (5) | (6) | (7) | (8) | (9) | (10) |

Test on Original Binder

| | | | | | | | | | |
|---|---|---|---|---|---|---|---|---|---|
| Dynamic | 1.00⁺ | 58° C. | 1.02 | 1.08 | 1.29 | 2.48 | 1.07 | 1.52 | 3.49 |
| Shear, | | | | | | | | | |
| G*/Sin (δ), | | | | | | | | | |
| (kPa), | | | | | | | | | |
| AASHTO | | | | | | | | | |
| T315 | | | | | | | | | |
| Rotational | 3.0⁻ | 135° C. | 0.213 | 0.233 | 0.296 | 0.444 | 0.238 | 0.306 | 0.341 |
| Viscosity | | | | | | | | | |
| (Pa · s), | | | | | | | | | |
| AASHTO | | | | | | | | | |
| T316 | | | | | | | | | |

Tests on RTFO

| | | | | | | | | | |
|---|---|---|---|---|---|---|---|---|---|
| Dynamic | 2.20⁺ | 52° C. | 4.07 | 4.59 | 5.82 | — | 4.33 | 7.44 | — |
| Shear, | | 58° C. | 1.81 | 1.98 | 2.43 | 3.84 | 1.94 | 3.08 | 3.86 |
| G*/Sin (δ), | | | | | | | | | |
| (kPa), | | | | | | | | | |
| AASHTO | | | | | | | | | |
| T315 | | | | | | | | | |

Tests on (RTFO + PAV)

| | | | | | | | | | |
|---|---|---|---|---|---|---|---|---|---|
| Dynamic | 5000⁻ | 16° C. | 4920 | 5345 | 5595 | 5020 (22° C.) | 6070 | 6150 | 4780 (22° C.) |
| Shear, | | 19° C. | 3135 | 3380 | 3585 | 3295 (25° C.) | 3870 | 4030 | 3150 (25° C.) |
| G*Sin (δ), | | | | | | | | | |
| (kPa), | | | | | | | | | |
| AASHTO | | | | | | | | | |
| T315 | | | | | | | | | |
| BBR Creep | 300⁻ | −12° C. | 91 | 82 | 107 | 146 | 86 | 115 | 135 |
| Stiffness, | | −18° C. | 227 | 224 | 259 | 313 | 255 | 256 | 473 |
| (MPa), | | | | | | | | | |
| AASHTO | | | | | | | | | |
| T313 | | | | | | | | | |
| Bending | 0.300⁺ | −12° C. | 0.405 | 0.394 | 0.382 | 0.347 | 0.383 | 0.379 | 0.341 |
| Beam m- | | | | | | | | | |
| value | | | | | | | | | |
| AASHTO | | | | | | | | | |
| T313 | | | | | | | | | |
| | | −18° C. | 0.330 | 0.325 | 0.322 | 0.298 | 0.324 | 0.319 | 0.280 |

| | | | | | | | |
|---|---|---|---|---|---|---|---|
| Actual PG Grading | PG | PG | PG | PG | PG | PG | PG |
| | 52-28 | 52-22 | 58-28 | 58-16 | 52-22 | 58-28 | 58-22 |

The recycling method of the present invention provides an extremely simple, straightforward process for recycling asphalt waste materials that produces an end product that has predictable characteristics and that is more economical and environmentally friendly.

Any modifications to this method by one of ordinary skill in the art are considered to be within the scope of the present invention.

### REFERENCES

Ali, N., Chan, J. S., Potyondy, A., Bushman, R., and Bergen, A. (1995). “Mechanistic Evaluation of Asphalt Concrete Mixtures Containing Reclaimed Roofing Materials,” Proc., 74^{th} Annual Meeting of Transportation Research Board, Technical University of Nova Scotia and University of Saskatchewan, Canada.
Asbestos in Asphalt Shingles, Available at http://www.shinglerecycling.org/content/asbestos-asphalt-shingles, Construction Materials Recycling Association, Accessed February 2010.
Button, J. W., Williams, D., and Scherocman, J. A. (1995). “Shingles and Toner in Asphalt Pavements.” FHWA Report No. FHWA/TX-96/1344-2F, Texas Transportation Institute, College Station, Tex.
Ciesielski, S., Collins, R. (1993). “Current Nationwide Status of the Use of Waste Materials in Hot Mix Asphalt Mixtures and Pavements.” American Society for Testing Materials, Use of Waste Materials in Hot-Mix Asphalt, STP 1193, Philadelphia, p. 17.
Construction Material Recycling Association (CMRA). (2007). Recycling Tear-Off Asphalt Shingles: Best Practices Guide, Dan Krivit and Associates, St. Paul, Minn.
Davis, J. (2009). Roofing the Road—Using Asphalt Shingles as Binder, Asphalt: The Magazine of the Asphalt Institute, October 2009, p. 2.
Elseifi, M. A., L. N. Mohammad, I. Glover, I. Negulescu, W. H. Daly, and C. Abadie. (2010). Relationship between Molecular Compositions and Rheological Properties of Neat Asphalt Binder at Low and Intermediate Temperatures. Journal of Materials in Civil Engineering, ASCE, Vol. 22, No. 12, pp. 1288-1294.
Foo, K. Y., Hanson, D. I., and Lynn, T. A. (1999). “Evaluation of Roofing Shingles in Hot Mix Asphalt.” Journal of Materials in Civil Engineering, ASCE, Vol. 11, No. 1, 15-20.
Gardiner, M., Newcomb, D., and Weikle, B. (1993). “Permanent Deformation and Low Temperature Behavior of Roofing Waste Modified HMA.” Proc., Symposium for Recovery and Reuse of Discarded Materials and By-Products for Construction of Highway Facilities, University of Minnesota.
Gevrenov, J. (2008). Recycling Shingles into Roads, US EPA Perspective. Presentation Made at the Missouri Showcase, Utilization of Recycled Asphalt Shingles in Hot-Mix Asphalt.
Grzybowski, K. F. (1993). “Recycled Asphalt Roofing Materials—A Multifunctional Low Cost Hot-Mix Asphalt Pavement Additive.” Use of Waste Materials in Hot-Mix Asphalt, ASTM STP-1193, Philadelphia, 159-179.
Jensen, W., and Abdelrahman, M. (2006). “Crumb Rubber in Performance Graded Asphalt Binder.” Report No. SPR-01 (05) P585, Lincoln, Nebr.
Malik, R., Teto, M. R., and Mogawer, W. (2000). “Evaluation of Use of Manufactured Waste Asphalt Shingles in Hot Mix Asphalt.” Technical Report # 26, Chelsea Center for Recycling and Economic Development, University of Massachusetts, Lowell, Mass.
Marks, V. J., and Petermeier, G. (1997). “Let Me Shingle Your Roadway.” Transportation Research Record 1589, TRB, National Research Council, Washington, D.C., 54-57.
National Association of Home Builders. (1998). From Roofs to Roads . . . Recycling Asphalt Roofing Shingles into Paving Materials, NAHB Research Center, Upper Marlboro, Md.
Northeast Recycling Council, Inc. (2007). Asphalt Shingles Waste Management in the Northeast—Fact Sheet.
Roof Types—Asphalt Composition Shingle Roofing Information, Available at http://www.roofhelp.com/choices/asphaltshingles/Accessed February 2010.
Rubino, B., Ashlock, J. C., and Williams, R. C. (2010). “Effects of Recycled Asphalt Shingles on Mechanical Properties of Loess.” Paper presented at the 89^{th} Transportation Research Board Annual Meeting, Washington, D.C.
Sengoz, B., and Topal, A. (2004). “Use of Asphalt Roofing Shingle Waste in HMA.” Construction and Building Materials, Vol. 19, 337-346.
Xiao, F., Shivaprasad, P. V., and Amirkhanian, S. N. (2011). “Low Volume WMA Mixtures: Moisture Susceptibility of Mixtures Containing Coal Ash and Roofing Shingle with Moist Aggregate.” Paper No. 11-3503 Presented at the 90^{th} Transportation Research Board Annual Meeting, Washington, D.C.
Watson, D. E., Johnson, A., and Sharma, H. R. (1998). “Georgia's Experience with Recycled Roofing Shingles in Asphaltic Concrete.” Transportation Research Record 1638, TRB, National Research Council, Washington, D.C., 129-133.

### EMBODIMENTS OF THE INVENTION INCLUDE

1. A method of recycling asphalt waste materials comprising blending ground asphalt waste material with virgin asphalt binder.
2. The method above wherein said asphalt waste material is reduced to a fine powder size of approximately 200 mesh.
3. The method above wherein said virgin asphalt binder is heated to a temperature in a range of approximately 170 to 180 degrees Celsius.
4. The method above wherein said asphalt waste material is blended with said virgin asphalt binder at a modification rate of 10% to 40% by weight of said virgin asphalt binder to produce a modified asphalt binder.
5. The method above further comprising mixing said modified asphalt binder with aggregate.

The complete disclosures of all references cited in this specification are hereby incorporated by reference. Specifically incorporated by reference is Appendix A: Elseifi, M. A., Saman Salari, Louay N. Mohammad, Marwa Hassan, William Daly, and Samer Dessouky. A New Approach to Recycle Asphalt Shingles in Hot Mix Asphalt. In the event of an otherwise irreconcilable conflict, however, the present specification shall control

1. A process for producing hot mix asphalt from recycled, asphalt-containing roofing shingles; asphalt binder; and aggregate; said process comprising the steps of:
(a) grinding the shingles to a powder, such that at least 80% by mass of the ground shingles pass a 200 mesh sieve;
(b) heating the asphalt binder to 170 to 180 degrees Celsius;
(c) blending the ground shingles with the heated asphalt binder; wherein the ground shingles are unheated immediately prior to said blending step; wherein no aggregate is included with the ground shingles and asphalt binder during said blending step; and wherein said blending step continues until substantially all asphalt from the ground shingles is melted and blended with asphalt from the asphalt binder; and
(d) mixing the melted blend of ground shingles and asphalt binder from step (c) with aggregate to produce hot mix asphalt.
